(19) United States
(12) Patent Application Publication
(10) Pub. No.: US 2026/0137078 A1
(43) Pub. Date: May 21, 2026

(54) PROCESS FOR COATING SEED, AND COATED SEED

(71) Applicant: GELITA AG, Eberbach (DE)

(72) Inventors: Holger BECKER, Eberbach (DE); Ulrich MACH, Ulm (DE); Berthold KÖHLER, Neckergemünd (DE); Catharina SCHÄFER, Neckarsteinach (DE)

(21) Appl. No.: 19/451,036

(22) Filed: Jan. 16, 2026

Related U.S. Application Data
(63) Continuation of application No. PCT/EP2024/061860, filed on Apr. 30, 2024.

(30) Foreign Application Priority Data
Jul. 20, 2023 (DE) 102023119222.1

(51) Int. Cl. A01N 25/24; A01C 1/06; A01P 3/00; A01P 7/04; A01P 21/00

(52) U.S. Cl. CPC A01N 25/24; A01C 1/06; A01P 3/00; A01P 7/04; A01P 21/00

(57) ABSTRACT

The present invention relates to a method for coating seed, comprising the steps of:
providing an aqueous coating solution which comprises a gelatine having a Bloom value of approximately 150 g or less and a viscosity of approximately 2.5 mPa·s or less, wherein the viscosity is measured on a 6.67% gelatine solution at 60° C.; and
applying the coating solution to the surface of the seed and letting the coating solution dry in order to obtain a gelatine-based coating on the seed.

### CROSS-REFERENCE TO RELATED APPLICATIONS

This patent application is a continuation of International Patent Application No. PCT/EP2024/061860, filed Apr. 30, 2024, which claims priority to European Patent Application No. 10 2023 119 222.1, filed Jul. 20, 2023, each of which is hereby incorporated by reference in its entirety.

### BACKGROUND OF THE INVENTION

It is known to coat seed prior to sowing. Such a coating can serve on the one hand to protect the seed during storage and transport. Primarily, however, the coating can be used for promoting growth by adding to it plant nutrients and/or crop protection agents which are released from the coating after sowing.

Known coating materials for seed frequently contain synthetic polymers such as polyvinyl acetate, polyvinyl alcohol, polyvinyl pyrrolidone or polyacrylates, which are not biodegradable or are only very poorly biodegradable and therefore lead to environmental pollution of the soil and groundwater, in particular in the form of microplastics.

### BRIEF SUMMARY OF THE INVENTION

The present invention relates to a method for coating seed.

The invention further relates to a seed which is coated according to this method.

The object of the invention is to propose a method for coating seed which leads to a biodegradable coating.

This object is achieved in accordance with the invention by a method for coating seed, comprising the steps of:
providing an aqueous coating solution comprising a gelatine having a Bloom value of approximately 150 g or less and a viscosity of approximately 2.5 mPa·s or less, wherein the viscosity is measured on a 6.67% gelatine solution at 60° C.; and
applying the coating solution to the surface of the seed and letting it dry in order to obtain a gelatine-based coating on the seed.

### DETAILED DESCRIPTION OF THE INVENTION

In the method according to the invention, the seed is provided with a gelatine-based coating. The use of gelatine has long been known in various technical fields, in particular in the food industry and in the pharmaceutical industry. As an extraction product from the collagen of animal connective tissue, gelatine is completely biodegradable and harmless to health and ecological purposes.

The physical and rheological properties of gelatine are characterized in particular by the Bloom value, i.e. the gel strength, and the viscosity. The standard methods for determining these two parameters are described in the GME monograph “Standardised Methods for the Testing of Edible Gelatine”. All Bloom values and viscosities mentioned in the context of this invention are to be determined according to these standard methods.

In order to be able to coat seed with gelatine, the gelatine must, on the one hand, exhibit sufficient gelling and film formation in order to form an effective protective layer on the seed grains. On the other hand, the aqueous coating solution should be readily processable with the available coating devices, in particular it should have good sprayability. These two requirements on the properties of the gelatine used are in opposition with one another. However, it has surprisingly been found in the context of the present invention that a gelatine having a Bloom value of approximately 150 g or less and a viscosity of approximately 2.5 mPa·s or less is outstandingly suitable for coating seed. The coating process can be carried out by means of known devices and an abrasion-resistant coating results on the seed grains. In addition, the dried coating is not tacky and the seed is thus spreadable.

The application of the coating solution to the surface of the seed and the drying of the coating solution are carried out in the method according to the invention substantially simultaneously within the scope of a continuous process. The coating solution is advantageously sprayed onto the surface of the seed, it being possible for this purpose to use various known coating devices, in particular a drum coater, a spin coater, a coating pan or a fluidized-bed dryer. The spray rate of the aqueous coating solution is typically in the range from 200 to 500 g/h.

The coating solution is preferably applied, in particular sprayed, onto the surface of the seed at a temperature of approximately 50° C. or more, more preferably of approximately 55° C. or more. At this temperature, the coating solution has a sufficiently low viscosity to be worked well. Higher temperatures of above 60° C. are generally disadvantageous since they can lead to thermal degradation of the gelatine.

The coating solution is preferably applied and left to dry at a temperature of approximately 30 to approximately 60° C. By evaporating the water from the coating solution at these temperatures, the gelatine-based coating is obtained on the seed.

The amount of coating solution applied to the seed may vary over a relatively wide range depending on the type of seed and the exact purpose of the coating. Typically, the coating solution is applied to the surface of the seed in an amount of approximately 50 to approximately 1,000 g per kilogram of seed.

According to the invention, the gelatine used in the coating solution has a viscosity of approximately 2.5 mPa·s or less. More preferably, the viscosity of the gelatine is approximately 2.3 mPa·s or less, in particular approximately 2.1 mPa·s or less, in each case measured on a 6.67% gelatine solution at 60° C.

The gelatine can be produced from a collagen-containing starting material from the skin or the bone of mammals. The collagen-containing starting material is, in particular, pig rind. It has been found that pig-rind gelatine can be used particularly advantageously within the scope of the invention.

The gelatine can be a type A or a type B gelatine, or a mixture thereof. Very suitable for the purposes of the invention is, for example, an acid-digested pig-rind gelatine of type A having a Bloom value in the range of approximately 100 g and a viscosity in the range of approximately 2 mPa·s. However, it is also possible to use gelatines of type B, for example bovine bone gelatines, having corresponding viscosity and Bloom values.

Various gelatines can also be characterized on the basis of the molecular weight or the molecular weight distribution, the molecular weight correlating to a certain extent with the Bloom value. The gelatine for the method according to the invention preferably has a weight-average molecular weight of approximately 20 to approximately 100 kDa, more preferably of approximately 39 to approximately 84 kDa. The weight-average molecular weight of gelatine is determined in particular by means of gel permeation chromatography.

In order to further optimize the rheological properties of the coating solution, it may be advantageous, depending on the type of gelatine used, if the coating solution further comprises one or more protein hydrolysates. These are preferably selected from collagen hydrolysate, hydrolysates of vegetable proteins and mixtures thereof. Preferred vegetable proteins for the production of corresponding hydrolysates are, in particular, soybean proteins, wheat proteins and whey proteins.

Collagen hydrolysate is prepared from gelatine or directly from a collagen-containing starting material by chemical or enzymatic hydrolysis. Because of its low molecular weight, collagen hydrolysate has no gelling capability. The collagen hydrolysate used in the method according to the invention preferably has a weight-average molecular weight of approximately 0.5 to approximately 18 kDa, more preferably from approximately 2 to approximately 5 kDa, in particular from approximately 2.5 to approximately 3.5 kDa.

By replacing a part of the gelatine with collagen hydrolysate—or another protein hydrolysate—the molecular weight distribution of the peptides contained in the coating solution as a whole can be specifically influenced. From this point of view, it is generally preferred if the coating solution comprises a proportion of at least approximately 10% by weight of gelatine and optionally protein hydrolysate with a molecular weight of up to 18 kDa, in relation to the total amount of gelatine and protein hydrolysate.

It is furthermore preferred if the coating solution comprises a proportion of at least approximately 40% by weight of gelatine and optionally protein hydrolysate with a molecular weight of up to 39 kDa, in relation to the total amount of gelatine and protein hydrolysate.

In a preferred embodiment of the invention, the coating solution comprises a total of approximately 5 to approximately 30% by weight of gelatine and optionally protein hydrolysate, preferably approximately 8 to approximately 20% by weight.

The coating solution may further comprise one or more crosslinking agents for gelatine, which is preferably selected from tannins, polyphenols and aldehydes such as glyoxal, glutaraldehyde and formaldehyde. Crosslinking of the gelatine can influence the solubility and the water absorption capacity of the coating, and the crosslinked gelatine also remains biodegradable, even if possibly over a relatively long period of time. Preference is given here to natural crosslinking agents such as tannins or tannin-containing plant extracts.

Furthermore, it may be advantageous if the coating solution further comprises one or more plasticizers, which are preferably selected from sugar alcohols and sugars, in particular from glycerol, sorbitol, sorbitan, mannitol, maltitol, xylitol, glucose and sucrose, or from propylene glycol, polypropylene glycol and polyethylene glycol. Such plasticizers can increase the flexibility of the coating and reduce friability, as is known, for example, from the field of soft gelatine capsules.

It is particularly advantageous if the coating solution further comprises one or more active ingredients which are preferably selected from plant nutrients, growth-promoting substances and crop protection agents such as insecticides and fungicides. Such active ingredients in the coating, which are released after sowing into the soil, can promote seed germination and the growth of the plants in a targeted manner. Apart from such active ingredients, the gelatine-based coating, however, also has a growth-promoting effect due to its water absorption capability: after sowing, the gelatine can absorb several times its own weight of water from the soil and form a hydrogel which optimizes the water supply of the seed grains.

In addition to gelatine, water and the aforementioned ingredients, the coating solution can comprise further components in order to specifically adapt the properties or the functionality of the coating. In particular, the coating solution can comprise one or more additives and/or fillers selected from pigments such as titanium dioxide and ferric oxides, minerals such as bentonites and kaolin, biodegradable fibers such as cellulose and keratin, polysaccharides such as starch and chitosan, or mixtures thereof.

The method according to the invention is suitable for coating any type of seed. Preferably, the seed is selected from cereal seeds, for example wheat, rye, barley, oats, corn, rice and millet, from seeds of
legumes, for example beans, peas, lentils, soybeans, chickpeas, sweet peas and lupins, from pseudocereal seeds, for example buckwheat, quinoa and amaranth, or from oilseeds, for example rape, flax and sunflower. The method according to the invention can also be used for the seeds of further species of crop plants or ornamental plants.

The present invention further relates to the use of an aqueous coating solution for coating seed, wherein the coating solution comprises a gelatine having a Bloom value of approximately 150 g or less and a viscosity of approximately 2.5 mPa·s or less, wherein the viscosity is measured on a 6.67% gelatine solution at 60° C.

Particular advantages and preferred embodiments of the use according to the invention have already been explained in conjunction with the method according to the invention.

These and other advantages of the invention will be explained in more detail with reference to the following practical example, which however do not restrict the subject matter of the invention in any way.

### Used Gelatine Types and Collagen Hydrolysate

The commercially available gelatine types listed in Table 1 were used in the context of the following practical examples for carrying out the method according to the invention. These are gelatines of type A from pig rind (porcine skin) or from bovine split (bovine hide).

TABLE 1

| | Bloom value | Viscosity | weight-average |
|---|---|---|---|
| | at 6.67% | at 6.67% | molecular |
| Gelatine type | and 60° C. | and 60° C. | weight |
| GELITA Porcine Skin | 139 g | 2.4 mPa · s | 83.3 kDa |
| Gelatine 140 Bloom | | | |
| (abb.: PS140) | | | |
| GELITA Porcine Skin | 100 g | 1.9 mPa · s | 69.7 kDa |
| Gelatine 100 Bloom | | | |
| (abb.: PS100) | | | |
| GELITA Bovine Hide | 68 g | 2.0 mPa · s | 78.4 kDa |
| Gelatine 60 Bloom | | | |
| (abb.: BH60) | | | |

For the gelatine type PS100, the molecular weight distribution determined by gel permeation chromatography is shown in Table 2:

TABLE 2

| Molecular weight from | | Molecular weight to | | Proportion | |
|---|---|---|---|---|---|
| 558 | kDa | 401 | kDa | 0.50% | by weight |
| 401 | kDa | 255 | kDa | 4.63% | by weight |
| 255 | kDa | 124 | kDa | 12.77% | by weight |
| 124 | kDa | 67.2 | kDa | 13.57% | by weight |
| 67.2 | kDa | 41.3 | kDa | 12.43% | by weight |
| 41.3 | kDa | 28.0 | kDa | 11.67% | by weight |
| 28.0 | kDa | 16.8 | kDa | 16.76% | by weight |
| 16.8 | kDa | 9.40 | kDa | 27.66% | by weight |

From this distribution it can be seen that the preferred gelatine types comprise a high proportion of relatively low molecular weight peptides with a molecular weight of up to 18 kDa, in the case of PS100 of more than approximately 28% by weight. By adding collagen hydrolysate, this proportion of low molecular weight peptides in the coating solution can be further increased, which also results in a reduction of the Bloom value and the viscosity for the corresponding mixture of gelatine and collagen hydrolysate.

In the following practical examples, the mixtures of gelatine PS100 and a collagen hydrolysate with a weight-average molecular weight of 3.2 kDa (obtainable under the name GELITA Peptiplus) indicated in Table 3 were used:

TABLE 3

| | 75% by weight PS100 | | 50% by weight PS100 | |
|---|---|---|---|---|
| | 25% by weight | | 50% by weight | |
| Mixture | Peptiplus | | Peptiplus | |
| Bloom value at 6.67% | 55 | g | 25 | g |
| and 60° C. | | | | |
| Bloom value at 6.67% | 1.5 | mPa · s | 1.1 | mPa · s |
| and 60° C. | | | | |
| weight-average | 56.3 | kDa | 39.2 | kDa |
| molecular weight | | | | |

| | | |
|---|---|---|
| Peptide | at least 46% by weight | at least 64% by weight |
| proportion <18 kDa | | |

### Example 1

### Coating of Seed by Means of a Coating Vessel

For the coating of seed by means of a coating vessel, aqueous coating solutions with different gelatine types and with, in some cases, varying gelatine concentrations according to Table 4 were used. The coating solutions further comprise a pigment (titanium dioxide) in order to make the coating of the seed optically recognizable.

TABLE 4

| Example 1.1 | Example 1.2 | Example 1.3 |
|---|---|---|
| 15-20 g Gelatine PS100 | 5-10 g Gelatine PS140 | 18 g Gelatine BH60 |
| 5-8 g pigment | 5-10 g pigment | 5 g pigment |
| 75-80 g water | 90-95 g water | 82 g water |

These coating solutions were each used to coat 150 g of seed (chickpeas or green peas) in a coating pan. For this purpose, the solution is kept liquid above the gelling temperature at approximately 60° C. and sprayed onto the seed, at a process temperature in the coating pan of 20 to 24° C.

The coating solution is sufficient to completely coat and color the seed. A relatively thick coating results which adheres very well to the seed and forms a stable film which can be dried very well, is abrasion-resistant and is not tacky.

### Example 2

### Coating of Seed by Means of a Drum Coater

For the coating of seed by means of a drum coater with a spray head from the company Glatt, an aqueous coating solution of 18 g of gelatine PS100, 3-5 g of pigment (FeOₓ) and 82 g of water was used.

The temperature of the spray solution here is 50-66° C., the spray rate is 200 g/h, and the process temperature in the drum coater is 31-35° C.

Even 5 to 10% of the total coating solution is sufficient in this case to completely coat and color 100 g of seed (chickpeas or green peas). The entire coating solution leads to a thick coating envelope which adheres very well to the seed and forms a stable film which can be dried very well.

Alternatively, it was also possible to coat and color 100 g of seed completely with a 1:10 diluted gelatine solution (i.e. 1.8 g of gelatine PS100, 98.2 g of water and 3-5 g of pigment) under the same process parameters, although the time required was significantly extended.

### Example 3

Coating with Gelatine and Collagen Hydrolysate

For coating seed with the aid of a drum coater, the mixtures of gelatine PS100 and collagen hydrolysate according to Table 3 above were used in these examples. FeOₓ was used as pigment. The specific compositions of the coating solutions and the process parameters are given in Table 5:

TABLE 5

| Example 3.1 | Example 3.2 | Example 3.3 | Example 3.4 |
|---|---|---|---|
| 7.5 g PS100 | 7.5 g PS100 | 9 g PS100 | 9 g PS100 |
| 2.5 g Peptiplus | 2.5 g Peptiplus | 9 g Peptiplus | 9 g Peptiplus |
| 2 g pigment | 2 g pigment | 3 g pigment | 3 g pigment |
| 90 g water | 90 g water | 82 g water | 82 g water |
| Spray solution | Spray solution | Spray solution | Spray solution |
| 54-65° C. | 56-59° C. | 62-64° C. | 56-66° C. |
| Spray rate | Spray rate | Spray rate | Spray rate |
| 210 g/h | 480 g/h | 240 g/h | 240 g/h |
| Process temp. | Process temp. | Process temp. | Process temp. |
| 32° C. | 60° C. | 35° C. | 31-35° C. |

The coating was carried out in the drum coater as described in Example 2. The addition of collagen hydrolysate reduces the viscosity and the gelling temperature of the coating solution, so that the risk of the lines becoming clogged if the temperature of the spray solution is too low is reduced.

In all Examples 3.1 to 3.4, even 5 to 10% of the total coating solution is sufficient to completely coat and color 100 g of seed (chickpeas or green peas).

The entire coating solution results in a thick coating envelope which adheres very well to the seed and forms a stable film which can be dried very well.

In these examples too, it was possible to coat completely and color 100 g of seed with a 1:10 diluted gelatine/collagen hydrolysate solution (but the same pigment content) with the same process parameters, although the time required was significantly extended.

### Example 4

Coating of Seed with Further Ingredients

In these examples, a hydrophilic ingredient (ethanol) or a hydrophobic ingredient (medium-chain triglycerides, MCT) was added to the coating solution. These serve as model substances or as possible matrices/carriers for corresponding active ingredients which can be used in the coating of seed. The compositions are shown in Table 6:

TABLE 6

| Example 4.1 | Example 4.2 |
|---|---|
| 10-18 g Gelatine PS100 | 10-18 g Gelatine PS100 |
| 30 g ethanol | 18 g MCT |
| 82-90 g water | 82-90 g water |
| 3-5 g pigment (FeOₓ) | 3-5 g pigment (FeOₓ) |

The coating was carried out in a drum coater as described in Example 2. In these examples too, 100 g of seed (chickpeas or green peas), despite the addition of ethanol or MCT, could be completely coated with 5 to 10% of the total coating solution and colored. The entire coating solution leads to a thick coating envelope which adheres very well to the seed and forms a stable film which can be dried very well.

In Example 4.2 it was additionally found that the addition of MCT could reduce the tackiness of the coating, so that this addition can also be used advantageously to reduce the risk of the individual coated seed grains sticking together.

### Example 5

### Addition of Crosslinking Agents

The coating solutions according to the above examples can additionally contain a crosslinking agent in order to prolong the degradation time of the coating after sowing by crosslinking the gelatine.

As crosslinking agents, it is possible here to use, for example, tannin powder (in an amount of 0.1 to 2% by weight), olive leaf extract (0.1 to 15% by weight), glyoxal (1,000 ppm) or glutaraldehyde (100 ppm), in each case in relation to the amount of the coating solution.

I claim:

1. A method for coating seed, comprising the steps of:
providing an aqueous coating solution comprising a gelatine having a Bloom value of approximately 150 g or less and a viscosity of approximately 2.5 mPa·s or less, wherein the viscosity is measured on a 6.67% gelatine solution at 60° C.; and
applying the coating solution to the surface of the seed and letting it dry to obtain a gelatine-based coating on the seed.

2. A The method in accordance with claim 1, wherein the coating solution is sprayed onto the surface of the seed.

3. The method in accordance with claim 1, wherein the coating solution is applied to the surface of the seed at a temperature of approximately 50° C. or more.

4. The method in accordance with claim 1, wherein the coating solution is applied and left to dry at a temperature of approximately 30 to approximately 60° C.

5. The method in accordance with claim 1, wherein the coating solution is applied to the surface of the seed in an amount of approximately 50 to approximately 1,000 g per kilogram of seed.

6. The method in accordance with claim 1, wherein the gelatine has a Bloom value of approximately 125 g or less.

7. The method in accordance with claim 1, wherein the gelatine has a viscosity of approximately 2.3 mPa·s or less, preferably of approximately 2.1 mPa·s or less, measured on a 6.67% gelatine solution at 60° C.

8. The method in accordance with claim 1, wherein the gelatine is produced from a collagen-containing starting material from the skin or the bone of mammals.

9. The method in accordance with claim 1, wherein the gelatine is an acid-digested gelatine of type A, an alkaline-digested gelatine of type B, or a mixture thereof.

10. The method in accordance with claim 1, wherein the gelatine has a weight-average molecular weight of approximately 20 to approximately 100 kDa.

11. The method in accordance with claim 1, wherein the coating solution further comprises one or more protein hydrolysates, which are selected from collagen hydrolysate, hydrolysates of vegetable proteins and mixtures thereof.

12. The method in accordance with claim 11, wherein the collagen hydrolysate has a weight-average molecular weight of approximately 0.5 to approximately 18 kDa.

13. The method in accordance with claim 1, wherein the coating solution comprises a proportion of at least approximately 10% by weight of gelatine and optionally protein hydrolysate with a molecular weight of up to 18 kDa, in relation to the total amount of gelatine and protein hydrolysate.

14. The method in accordance with claim 1, wherein the coating solution comprises a proportion of at least approximately 40% by weight of gelatine and optionally protein hydrolysate with a molecular weight of up to 39 kDa, in relation to the total amount of gelatine and protein hydrolysate.

15. The method in accordance with claim 1, wherein the coating solution comprises a total of approximately 5 to approximately 30% by weight of gelatine and optionally protein hydrolysate, preferably approximately 8 to approximately 20% by weight.

16. The method in accordance with claim 1, wherein the coating solution further comprises one or more crosslinking agents for gelatine, which is selected from tannins, polyphenols and aldehydes such as glyoxal, glutaraldehyde and formaldehyde.

17. The method in accordance with claim 1, wherein the coating solution further comprises one or more plasticizers, which are selected from sugar alcohols and sugars, such as glycerol, sorbitol, sorbitan, mannitol, maltitol, xylitol, glucose and sucrose, or propylene glycol, polypropylene glycol and polyethylene glycol.

18. The method in accordance with claim 1, wherein the coating solution further comprises one or more active ingredients which are selected from plant nutrients, growth-promoting substances and crop protection agents such as insecticides and fungicides.

19. The method in accordance with claim 1, wherein the coating solution further comprises one or more additives and/or fillers, which are selected from pigments such as titanium dioxide and iron oxides, minerals such as bentonites and kaolin, biodegradable fibers such as cellulose and keratin, polysaccharides such as starch and chitosan, or mixtures thereof.

20. The method in accordance with claim 1, wherein the seed is selected from cereal seeds, for example wheat, rye, barley, oats, corn, rice and millet, from seeds of legumes, for example beans, peas, lentils, soybeans, chickpeas, sweet peas and lupins, from pseudocereal seeds, for example buckwheat, quinoa and amaranth, or from oilseeds, for example rape, flax and sunflower.

21. (canceled)

22. A seed with a gelatine-based coating, wherein the seed is produced according to the method in accordance with claim 1.

23. The method in accordance with claim 6, wherein the gelatine has a Bloom value of approximately 100 g or less.

24. The method in accordance with claim 7, wherein the gelatine has a viscosity of approximately 2.1 mPa·s or less, measured on a 6.67% gelatine solution at 60° C.
